(19) United States
(12) Patent Application Publication
(10) Pub. No.: US 2014/0223500 A1
(43) Pub. Date: Aug. 7, 2014

(54) METHOD AND SYSTEM FOR TRANSMITTING WIRELESSLY VIDEO IN PORTABLE TERMINAL

(71) Applicant: Samsung Electronics Co., Ltd., Suwon-si (KR)

(72) Inventors: Jaeki YOU, Suwon-si (KR); Soungkwan KIMN, Pyeongtaek-si (KR); Taehyung KIM, Yongin-si (KR); Kwanwoong SONG, Seongnam-si (KR); Jungwook CHAI, Seoul (KR)

(73) Assignee: Samsung Electronics Co., Ltd., Suwon-si (KR)

(21) Appl. No.: 14/170,976

(22) Filed: Feb. 3, 2014

(30) Foreign Application Priority Data
Feb. 4, 2013 (KR) 10-2013-0012353

(51) Int. Cl. H04N 21/41; H04N 21/472

(52) U.S. Cl. CPC H04N 21/4126; H04N 21/47202
USPC 725/87

(57) ABSTRACT

A method and a system for transmitting a video wirelessly in a portable terminal are provided. The method includes connecting a data channel to transmit a multimedia data and a control channel to transmit a control command when activating a wireless video transmission mode which may transmit the multimedia data wirelessly, and transmitting a transmission requested multimedia data to a reception terminal through the data channel when transmission of the multimedia data is requested, and transmitting a current volume information to the reception terminal through the control channel.

### CROSS-REFERENCE TO RELATED APPLICATION(S)

This application claims the benefit under 35 U.S.C. §119(a) of a Korean patent application filed on Feb. 4, 2013 in the Korean Intellectual Property Office and assigned Serial number 10-2013-0012353, the entire disclosure of which is hereby incorporated by reference.

### TECHNICAL FIELD

The present disclosure relates to a method and a system for transmitting a video wirelessly in a portable terminal More particularly, the present disclosure relates to a method and a system for transmitting a video wirelessly in a portable terminal which may transmit a control command input from a transmission terminal in real time when using a wireless video transmitting service.

### BACKGROUND

Recent portable terminals provide diverse functions that are desired by users. For example, portable terminals provide functions such as a call function, an image or a video photographing function, a broadcasting reception function, and an interne access function.

Recent portable terminals (e.g., a transmission terminal) may provide a wireless video transmission function which may transmit a video (a multimedia data) to other terminals (reception terminal) through a wireless communication (for example, Wi-Fi, Bluetooth, and other mobile communication networks). The wireless video transmission function includes a Wi-Fi Display (WFD), a Wireless Display (WiDi), and a Miracast.

In general, the wireless video transmission function may transmit a multimedia file (e.g., a video and a music file, etc.) in real time. Likewise, when transmitting a high-capacity multimedia file in real time, the reception terminal typically stores and plays data in a buffer of a certain size (or time) so as to avoid fluctuation characteristics of a wireless communication channel and provide a continuous screen. In addition, the transmission terminal may transmit a control command to the reception terminal. The control command is included in a stream data to transmit. Thus, in a conventional wireless video transmission function, a control command input from the transmission terminal cannot be processed in real time in the reception terminal.

For example, the transmission terminal may transmit data to the reception terminal after converting into a stream format when playing a movie file. The reception terminal may convert and display the received stream format data. When a volume is changed in the transmission terminal, the transmission terminal may apply a gain corresponding to the changed volume to a stream format data, and may transmit the stream format data to which the changed volume is applied to the reception terminal. Likewise, when transmitting data after applying the changed volume to the stream format data, the reception terminal may play a movie data with an unchanged volume until the stream format data is decoded in the reception terminal In other words, the wireless video transmission function according to the related art has a problem in that a volume change of the transmission terminal is not reflected to the reception terminal in real time.

In addition, a wireless video transmitting technology based on a Digital Living Network Alliance (DLNA) has a problem that a volume change in the transmission terminal is not reflected to the reception terminal As a result, in the wireless video transmitting technology based on the DLNA, there exists an inconvenience that a volume control is possible only in the reception terminal

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a wireless video transmitting method and a system in a portable terminal which enables to transmit a control command of a transmission terminal to a reception terminal in real time when providing a wireless video transmitting service.

In accordance with an aspect of the present disclosure, a method of transmitting a video wirelessly in a portable terminal is provided. The method includes connecting a data channel to transmit a multimedia data and a control channel to transmit a control command when activating a wireless video transmission mode so as to transmit the multimedia data wirelessly, transmitting a transmission requested multimedia data to a reception terminal through the data channel when transmission of the multimedia data is requested, and transmitting current volume information to the reception terminal through the control channel.

In accordance with another aspect of the present disclosure, a system for transmitting a video wirelessly in a portable terminal is provided. The system includes a transmission terminal configured to form a data channel to transmit a multimedia data and a control channel to transmit a control command with a reception terminal when activating a wireless video transmission mode to transmit the multimedia data wirelessly, to transmit a requested multimedia data to the reception terminal through the data channel when transmission of the multimedia data is requested, and to transmit a current volume information to the reception terminal through the control channel, and a reception terminal to apply the volume information received from the transmission terminal through the control channel to the multimedia data received from the transmission terminal through the data channel and to reproduce the multimedia data according to the applied volume information.

In accordance with another aspect of the present invention, a portable terminal is provided. The portable terminal includes a display unit, a communication unit configured to transmit multimedia data to a reception terminal over a data channel and to transmit a control command for controlling reproduction of the multimedia data to the reception terminal over a control channel, an input unit configured to receive user input for the control command, and a controller configured to form the data channel and the control channel to transmit a control command when activating a wireless video transmission mode to transmit the multimedia data wirelessly, to control the communication unit the transmit the multimedia data to the reception terminal through the data channel when transmission of the multimedia data is requested, and to control the communication unit to transmit a current volume information to the reception terminal through the control channel.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a system for providing a wireless video transmitting service according to an embodiment of the present disclosure;

FIG. 2 is a flowchart explaining a procedure of providing a wireless video transmitting service according to an embodiment of the present disclosure;

FIG. 3 is a schematic block diagram illustrating a configuration of a transmission terminal and a reception terminal according to an embodiment of the present disclosure;

FIG. 4 is a flowchart explaining a wireless video transmitting method in a transmission terminal according to an embodiment of the present disclosure; and

FIG. 5 is a flowchart explaining a wireless video transmitting method in a reception terminal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An embodiment of the present disclosure is related to a system which may transmit a screen between the terminals through a wireless communication. Hereinafter, embodiments of the present disclosure will be described with respect to a transmission terminal and a reception terminal. A transmission terminal according to an embodiment of the present disclosure may be a portable terminal having a relatively small screen such as a mobile communication terminal, a smart phone, a tablet Personnel Computer (PC), a portable multimedia player, and a personal digital assistant, etc. The reception terminal may be a portable terminal or an electronic device having a relatively large screen such as a desktop PC, a Notebook computer, and a smart TV.

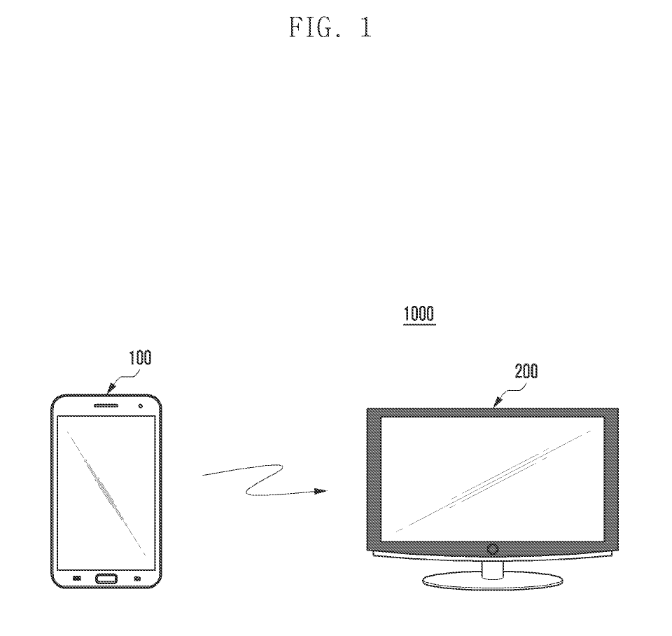

FIG. 1 is a schematic diagram illustrating a system for providing a wireless video transmitting service according to an embodiment of the present disclosure.

Referring to FIG. 1, a system 1000 according to an embodiment of the present disclosure may include a transmission terminal 100 and a reception terminal 200. As described above, the transmission terminal 100 may be a portable terminal having a relatively small screen, and the reception terminal 200 may be the electrical instrument having a relatively large screen.

The transmission terminal 100 may form a communication channel to transmit a video wirelessly with the reception terminal 200. The transmission terminal 100 may connect a data channel for transmitting data and a control channel for transmitting a control command with the reception terminal 200. The data channel is a communication channel of a Transmission Control Protocol (TCP) scheme and a User Datagram Protocol (UDP) scheme, and the control channel is a communication channel of a Real Time Streaming Protocol (RTSP) scheme.

When the reception terminal 200 and the communication channel are connected, the transmission terminal 100 may transmit data and a control command to the reception terminal 200 in real time. The transmission terminal 100 may transmit multimedia data (e.g., a movie file) to the reception terminal 200 through the data channel after converting into a stream format. In addition, the transmission terminal 100 may transmit a control command to the reception terminal 200 through the control channel. The control command is a command to control reproduction of data. For example, the control command may include a volume change, pause, play (Resume), stop, play next file, play previous file, and the like.

The reception terminal 200 may form a communication channel to wirelessly receive a video with a transmission terminal The communication channel may include a data channel and a control channel. When the communication channel is formed, the reception terminal 200 may receive multimedia data which is converted into a streaming format from the transmission terminal 100 through the data channel, and may play the received multimedia data after reverse conversion. In addition, the reception terminal 200 may receive a control command (e.g., a volume change, pause, play (Resume), quit playing, next file play, and previous file play, etc.) from the transmission terminal 100 through the control channel, and may perform a function corresponding to the control command.

In a system according to an embodiment of the present disclosure described above, the transmission terminal may transmit a control command through the control channel instead of the data channel without any time delay, and may process the control command of the transmission terminal in the reception terminal in real time.

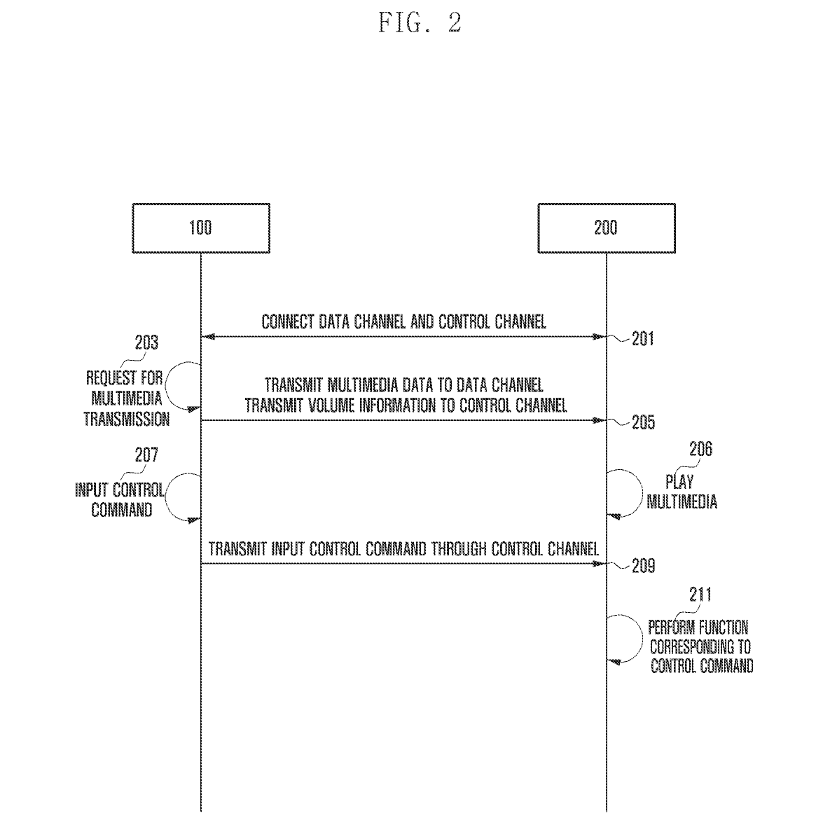

FIG. 2 is a flowchart explaining a procedure of controlling a wireless video transmitting service according to an embodiment of the present disclosure.

Referring to FIG. 2, the transmission terminal 100 may connect a reception terminal 200 with a data channel and a control channel when a wireless video transmitting mode is activated at operation 201. The transmission terminal 100 may detect a transmission request of a multimedia data at operation 203. The multimedia data may be video data.

When the transmission of the multimedia data is requested, the transmission terminal 100 may transmit the multimedia data through the data channel, and may transmit volume information through the control channel at operation 205. The transmission terminal 100 may transmit the multimedia data after converting into a streaming format. The transmission terminal 100 may transmit the multimedia data which is converted as the streaming format after storing the converted multimedia data in a transmission buffer with a certain amount for continuous transmission. In addition, the transmission terminal 100 may transmit a gain value or a volume index value corresponding to a volume level through the control channel. When transmitting the volume index value, the transmission terminal 100 may also transmit a volume mapping table which maps the index value to the gain value to the reception terminal 100 together with the volume index value. In addition, the transmission terminal 100 according to an embodiment of the present disclosure may previously transmit the volume mapping table to the reception terminal 200 after operation 201.

The reception terminal 200 may play multimedia data at operation 206. The reception terminal 200 may play multimedia data received through the data channel based on volume information received through the control channel. The reception terminal 200 may reverse convert and play the multimedia data of the streaming format stored in the reception buffer after storing the multimedia data transmitted for a continuous play in a reception buffer as much as a certain size (or a certain time).

The transmission terminal 100 may detect an input of a control command at operation 207. The control command may include a volume change, pause, play (Resume), stop, play next file, play previous file, and the like. When an input of the control command is detected, the transmission terminal 100 may transmit the input control command to the reception terminal 200 through the control channel at operation 209.

The reception terminal 200 which received the control command may perform a function corresponding to a control command at operation 211. For example, the reception terminal 200 may pause reproduction of multimedia data when the control command is a pause command. In addition, the reception terminal 200 may apply a gain value corresponding to the changed volume to the multimedia data stored in the reception buffer when the control command is a volume change command. Thus, the reception terminal 200 may reflect a volume control command of the transmission terminal 100 in real time.

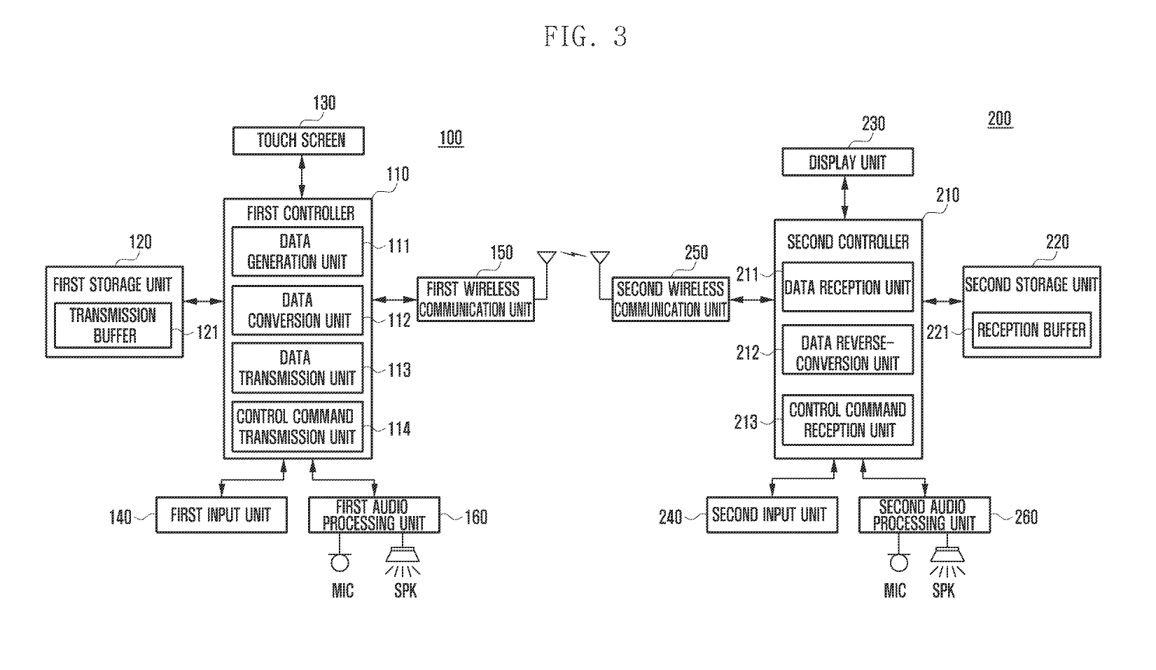

FIG. 3 is a schematic block diagram illustrating a configuration of a transmission terminal and a reception terminal according to an embodiment of the present disclosure.

Referring to FIG. 3, the transmission terminal 100 may include a first controller 110, a first storage unit 120, a touch screen 130, a first input unit 140, a first wireless communication unit 150, and a first audio processing unit 160. The first controller 110 may include a data generation unit 111, a data conversion unit 112, a data transmission unit 113, and a control command transmission unit 114, and the first storage unit 12 may include a transmission buffer 121.

The first audio processing unit 160 may be connected to a Speaker (SPK) to output an audio signal transmitted and received during a call, an audio signal included in the received message, and an audio signal according to reproduction of multimedia data stored in the storage unit 120, and to a Microphone (MIC) to collect a user's voice or other audio signals. The first audio processing unit 160 may output a sound effect according to a control command input and a sound effect according to a touch of the touch screen 130 through the SPK.

The first wireless communication unit 150 may support a wireless communication function of the transmission terminal 100, and may include a mobile communication module when the transmission terminal 100 supports the mobile communication function. The first wireless communication unit 150 according to an embodiment of the present disclosure may form a communication channel to transmit the video wirelessly. The communication channel may include a data channel and a control channel. The first wireless communication unit 150 may transmit the multimedia data to the reception terminal 200 through the data channel under the control of the first controller 110, and may transmit the control command through the control channel to the reception terminal 200. Such wireless communication unit 150 may be formed of a Wi-Fi communication module.

The first input unit 140 may receive a number or character information, and may include a plurality of input keys and function keys to set various functions. The function keys may include an arrow key, a side key, and a shortcut key which are set to perform the specific functions. In addition, the input unit 140 may generate a key signal related to a user setting and a function control of the transmission terminal 100 and deliver to the first controller 110. The first input unit 140 may be formed by any input means, such as a QWERTY keypad, a 3*4 keypad, a 4*3 keypad, a Ball Joystick, an Optical Joystick, a Wheel Key, a Touch key, a Touch Pad, and a Touch Screen, or a combination thereof. The first input unit 140 may include only a volume key for volume control formed in a side of the case of transmission terminal 100, and a function key to turn a screen on/off and a power on/off when the transmission terminal 100 supports a full touch screen. The first input unit 140 according to the present disclosure may include a function key to input a control command such as a volume control, multimedia data play, pause, play previous file, and play next file.

The touch screen 130 may provide an input function and an output function. The touch screen 130 may include a display unit (not shown) and a touch input unit (not shown). The display unit may display various menus as well as information input by the user, or information to provide to the user. The display unit may provide various screens according to a usage of the transmission terminal 100 such as a home screen, a message writing screen, a web page screen, and a call screen, and the like. The display unit according to an embodiment of the present disclosure may provide a screen to control the wireless video transmission, for example, a screen selecting a multimedia data to be transmitted, and a screen to input a control command to control reproduction of the multimedia data. The display unit may be formed of a Liquid Crystal Display (LCD), an Organic Light Emitted Diode (OLED), and an Active Matrix Organic Light Emitted Diode (AMOLED).

The touch input unit is a device to provide an input function, and may generate a touch event when a touch input device, for example, a user's finger, a stylus, and an electronic pen is contacted or accessed, and may deliver the generated touch event to the first controller 110. The touch input unit may recognize a generation of a touch event through a change of a physical quantity (e.g., a capacitance, a resistance value) according to the touch or the access of the touch input device, and may deliver to the first controller 110. The touch input unit according to the present disclosure may generate a touch signal to control a wireless video transmission service, for example, a touch signal to select a multimedia to be transmitted, a touch signal requesting a transmission of the selected multimedia data, and a touch signal to control a play of the multimedia data, and may transmit thereof to the first controller 110.

The first storage unit 120 may store an Operating System (OS) of the transmission terminal 100, as well as application programs for other optional functions, for example, a sound play function, an image or a video play function, and a broadcasting play function. The first storage unit 120 may also store user data and transmitting and receiving data. For example, the first storage unit 120 may store a video file, a game file, a music file, and a movie file. The first storage unit 120 according to the present disclosure may also store a volume mapping table. A volume index indicating a volume level stage (e.g., stage 15) and a gain value of an amplifier (not shown) to amplify an audio signal are mapped in the volume mapping table. For example, a gain value ranging from 0.1 to 1.0 may be mapped in the volume level stage 1 to stage 15.

The first storage unit 120 may store a wireless video transmission program to provide a service of transmitting a video wirelessly to other terminal The wireless video transmission program may include a data generating routine which generates a media clip data by cutting the transmitted multimedia data by a certain size, a data conversion routine which converts the media clip data into a streaming format, a data transmission routine which transmits the converted data, and a controlling routine which transmits a control command controlling a generation of the multimedia data.

The first storage unit 120 may include a transmission buffer 121. The transmission buffer 121 may temporarily store a data to be transmitted to the reception terminal 200 as much as a certain size (or time). This is to transmit a data continuously.

The first controller 110 may control an overall operation of the transmission terminal 100 and a signal flow between the internal blocks of the transmission terminal 100, and may perform a data processing function processing a data. The first controller 110 may be a Central Processing Unit (CPU) and an Application Processor. The first controller 110 may be formed as a single core processor or a multi core processor.

The first controller 110 may control a procedure of providing a wireless video transmission service which transmits a multimedia data wirelessly to other terminal. To this end, the first controller 110 may include a data generation unit 111, a data conversion unit 112, and a control command generating unit 113. The data generation unit 111 may generate a media clip data to the reception terminal 200 by splitting a transmission requested multimedia data into a certain size. The data conversion unit 112 may convert the generated media clip data into a form which is appropriate to a wireless transmission. The data transmission unit 113 may transmit the converted data to the reception terminal 200 through a data channel of the first wireless communication unit 150. The data transmission unit 113 may transmit the converted data to the reception terminal 200 after temporarily storing the converted data in the transmission buffer 121. This is to transmit a data without stopping regardless of a wireless environment change.

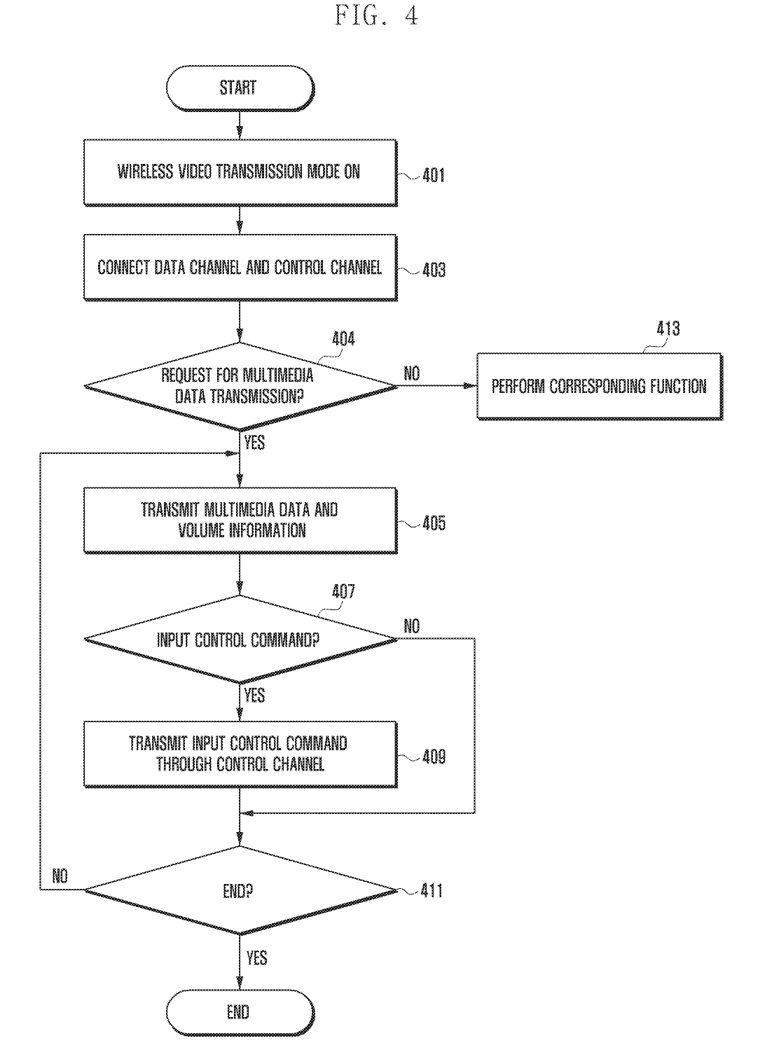

The control command transmission unit 114 may generate a control command providing volume information of the transmission requested multimedia data, and may transmit the generated control command to the reception terminal 200 through the control channel. In addition, the control command transmission unit 114 may generate a control command according to the control signal which is input during the play of multimedia and transmit to the reception terminal 200 through the control channel. The first controller 110 will be described below with reference to FIG. 4.

The reception terminal 200 may include a second controller 210, a second storage unit 220, a display unit 230, a second input unit 240, a second wireless communication unit 250, and a second audio processing unit 260. The second storage unit 220 may include a reception buffer 221, and the second controller 210 may include a data reception unit 211, a data reverse-conversion unit 212, and a control command reception unit 213. For a convenience of description, the description for the components of the reception terminal 200 that perform a similar function as components of the transmission terminal 100 will be omitted.

The second audio processing unit 260 may output an audio signal according to a generation of a multimedia data received from the transmission terminal 100. An output level of the audio signal may be controlled according to a control command received through the control channel.

The second storage unit 220 may include a reception buffer 221. The reception buffer 221 may temporarily store a multimedia data which is transmitted in real time as much as a certain size (or time). This is to play the multimedia data continuously. The reception buffer 221 may be included in a data reception unit 211 of the second controller 210.

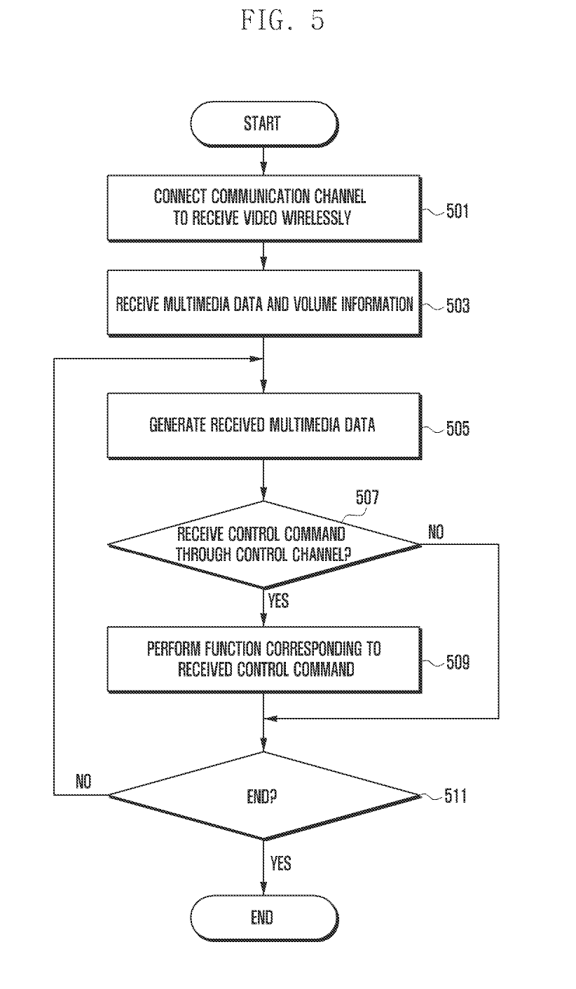

The second controller 210 may include a data reception unit 211, a data reverse-conversion unit 212, and a control command reception unit 213. The data reception unit 211 may receive the converted data which is transmitted by the transmission terminal 100 through a second wireless communication unit 250. The data reception unit 211 may store the converted data in the reception buffer 221 as much as a certain size. The data reverse-conversion unit 212 may reverse convert the converted data. The control command reception unit 210 may receive volume information from the transmission terminal 100, and may transmit the received volume information to the data reception unit 211. The second controller 210 may play the reverse converted data based on an output level of an audio signal according to the volume information. In addition, the control command reception unit 213 may receive a control command, such as pause, stop, play next, and play previous, from the transmission terminal 100. The second controller 210 may perform a function corresponding to the received control command. The description of the second controller 210 will be described below with reference to FIG. 5.

The reception terminal according to another embodiment of the present disclosure may form a communication channel with a transmission terminal, and may include a dongle which can receive and convert data, and a display device which can receive and display data from the dongle.

In addition, although not illustrated in FIG. 3, the transmission terminal 100 and the reception terminal 200 may selectively further include elements having an additional function such as a Global Positioning System (GPS) module for receiving position information, a broadcast reception module for receiving a broadcast, and a digital music play module such as a MP3 module. Since the variation of such elements is very diverse according to the trend of digital convergence, these additional components are not described herein; however, the transmission terminal 100 and the reception terminal 200 according to the present disclosure may further include the elements those have equivalent levels to the elements described above.

FIG. 4 is a flowchart explaining a wireless video transmission method in a transmission terminal according to an embodiment of the present disclosure.

Referring to FIG. 4, the first controller 110 of the transmission terminal 100 may detect an activation (ON) of a wireless video transmission mode at operation 401. The wireless video transmission mode may be a Wi-Fi Display (WFD), a Wireless Display (WiDi), and a Miracast.

When the wireless video transmission mode is activated, the first controller 110 may connect a data channel, and a control channel with the reception terminal 200 through a first wireless communication unit 150 at operation 403. When the data channel and the control channel are connected, the first controller 110 may verify whether a transmission of a multimedia data is requested at operation 404. The first controller 110 may output a list of multimedia data stored in the first storage unit 120 so that the user may select the multimedia data to be transmitted, may detect a selection of specific multimedia data from the list, and may verify whether a transmission (or a reproduction) command of the selected multimedia data is received. When a transmission of the multimedia data is not requested, the first controller 110 may perform the corresponding function in operation 413. For example, the first controller 110 may perform a procedure of selecting a multimedia data to be transmitted according to the user's request, or may maintain the operation 404.

On the other hand, when a transmission of the multimedia data is requested, the first controller 110 may transmit in operation 405 the transmission requested multimedia data to the reception terminal 200 through the data channel, and may transmit volume information to the reception terminal 200 through the control channel. The data generation unit 111 of the first controller 110 may generate a media clip data by cutting the transmission requested multimedia by a certain size. The data conversion unit 112 of the first controller 110 may convert the generated media clip data into a format suitable for the data channel (e.g., a streaming format). The data transmission unit 113 may transmit the converted media clip data to the reception terminal 200 through the data channel of the wireless communication unit 150. The first controller 110 may transmit the converted media clip data after storing in the transmission buffer 121 as much as a certain size (or time) for continuous transmission. In addition, a control command transmission unit 114 of the first controller 110 may verify the current set volume level, and may transmit a gain value or a volume index value corresponding to the verified volume level to the reception terminal 200. When transmitting the volume index value as the volume information, the first controller 110 may transmit a volume mapping table together with the volume index value. In addition, the first controller 110 may transmit the volume mapping table to the reception terminal 200 after performing the operation 403.

The first controller 110 may verify whether a control command is input at operation 407. The control command is a command to control a play of the multimedia data, and may include a volume change, pause, play (Resume), stop, next file play, previous file play, and the like. When the control command is not input, the first controller 110 may proceed to operation 411 which will be described later. When the control command is input, the first controller 110 may control a control command transmission unit 114 so that the input control command may be transmitted to the reception terminal 200 through the control channel at operation 409. When the control command is a volume change command, the control command transmission unit 114 of the first controller 110 may transmit a gain value or a volume index value corresponding to the changed volume level to the reception terminal 200.

The first controller 110 may verify whether a termination signal is input at operation 411. The termination signal may be generated when the terminal signal is input by the user, or when the play of the multimedia file is completed. When the termination signal is not input, the first controller 110 may repeat the above described procedure by returning to operation 405. On the other hand, when the termination signal is input, the first controller 110 may terminate the wireless video transmission procedure shown in FIG. 4. At this time, a communication channel with the reception terminal 200 may be disconnected, or may be maintained according to a designer's intention.

FIG. 5 is a flowchart explaining a wireless video transmission method in a reception terminal according to an embodiment of the present disclosure.

Referring to FIG. 5, the second controller 210 of the reception terminal 200 may connect a communication channel to the transmission terminal 100 to receive a video wirelessly at operation 501. The communication channel may include a data channel for a data transmission and a control channel for a control command transmission.

The second controller 210 may receive a multimedia data and volume information at operation 503. The data reception unit 211 of the second controller 210 may receive a multimedia data transmitted from the transmission terminal 100 through a data channel. The data reception unit 211 may store the received multimedia data in a reception buffer 221 as much as a certain size. The data reverse-conversion unit 212 may reverse-convert multimedia data stored in the reception buffer 221. The reverse-converted multimedia data may be displayed on the display unit 230. The control command reception unit 213 may receive volume information (a gain value or a volume index value) of a multimedia data through the control channel. When the volume information is the volume index value, the second controller 210 may also receive a volume mapping table.

The second controller 210 may play the received multimedia data at operation 505. The second controller 210 may set an output level of an audio signal of the received multimedia data by using the volume information received through the control channel.

During the reproduction of the multimedia data, the second controller 210 may verify whether a control command is received through the control channel at operation 507. When the control command is not received, the second controller 210 may end the process at operation 511. On the other hand, when the control command is received through the control command reception unit 213, the second controller 210 may perform a function corresponding to the received control command at operation 509. For example, when a pause command is received, the second controller 210 may pause the reproduction of the multimedia data. When the control command is a volume change command, the second controller 210 may change an output level of an audio signal of the multimedia. A control command processing unit 212 of the second controller 210 may apply a gain value corresponding to the changed volume to the multimedia data stored in the reception buffer 221. When the volume information is a volume index value, the control command processing unit 212 may verify a gain value with reference to a volume mapping table, and may apply the verified gain value to the multimedia data.

The second controller 210 may verify whether a termination signal is input at operation 511. The termination signal may be received and input from the transmission terminal 100 when a user of the transmission terminal 100 terminates a play of the multimedia data, or the play of the multimedia file is completed. When the termination signal is not input, the second controller 210 may repeat the above described procedure by returning to operation 505. On the other hand, when the termination signal is input, the second controller 210 may terminate the wireless video transmission procedure of FIG. 5. At this time, the second controller 210 may disconnect, or maintain a communication channel connection with the transmission terminal 100.

An embodiment of the present disclosure described above may transmit a control command of the transmission terminal to the reception terminal without any time delay. Accordingly, the present disclosure may process a user's command through the transmission terminal in real time. For example, when controlling a volume of the multimedia data in the transmission terminal, the reception terminal may reflect a volume changed by the transmission terminal to a multimedia data which is playing in real time. Likewise, since a volume control of the transmission terminal is reflected to the reception terminal, and a volume control in the reception terminal is also possible in separate, an embodiment of the present disclosure is able to perform a delicate volume control. For example, when the transmission terminal is a device which is able to perform a volume control having 15 levels, and the reception terminal is a device which is able to perform a volume control having 100 levels, an embodiment of the present disclosure is able to perform a volume control with 1500 levels (=15*100) when playing the multimedia.

The foregoing method for transmitting a video wirelessly in a portable terminal of the present disclosure may be implemented in an executable program command form by various computer means and be recorded in a computer readable recording medium. In this case, the computer readable recording medium may include a program command, a data file, and a data structure individually or a combination thereof. In the meantime, the program command recorded in a recording medium may be specially designed or configured for the present disclosure or be known to a person having ordinary skill in a computer software field to be used. The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a compiler and a high-level language code executable by a computer using an interpreter. The foregoing hardware device may be configured to be operated as at least one software module to perform an operation of the present disclosure.

As described above, a wireless video transmission method and a system according to an embodiment of the present disclosure may transmit a control command to a reception terminal without any time delay. Thus, the present disclosure may process a user's command through a transmission terminal in real time. For example, when controlling a multimedia data volume in a transmission terminal, a reception terminal may reflect a volume changed by the transmission terminal to a playing multimedia in real time

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for transmitting a video wirelessly in a portable terminal, the method comprising:
connecting a data channel to transmit a multimedia data and a control channel to transmit a control command when activating a wireless video transmission mode so as to transmit the multimedia data wirelessly; and
transmitting a transmission requested multimedia data to a reception terminal through the data channel when transmission of the multimedia data is requested, and transmitting current volume information to the reception terminal through the control channel.

2. The method of claim 1, further comprising:
transmitting the control command to the reception terminal through the control channel when the control command is input; and
performing a function corresponding to the received control command by the reception terminal

3. The method of claim 2, wherein the control command comprises a volume change, pause, play (Resume), stop, play next file, and play previous file.

4. The method of claim 1 further comprising:
applying the volume information received through the control channel to the multimedia data received through the data channel and plays by the reception terminal.

5. The method of claim 1, wherein the volume information is at least one of a gain value or a volume index value.

6. The method of claim 5, wherein the transmitting of the volume information comprises:
transmitting a volume index value corresponding to a current volume and a volume mapping table in which the volume index value is mapped to a corresponding gain value.

7. The method of claim 1, wherein the data channel is a communication channel of a Transmission Control Protocol (TCP) type or a User Datagram Protocol (UDP) type, and the control channel is a communication channel of a Real Time Streaming Protocol (RTSP) type.

8. A system for transmitting a video wirelessly in a portable terminal, the system comprising:
a transmission terminal configured to form a data channel to transmit a multimedia data and a control channel to transmit a control command with a reception terminal when activating a wireless video transmission mode to transmit the multimedia data wirelessly, to transmit a requested multimedia data to the reception terminal through the data channel when transmission of the multimedia data is requested, and to transmit a current volume information to the reception terminal through the control channel; and
a reception terminal configured to apply the volume information received from the transmission terminal through the control channel to the multimedia data received from the transmission terminal through the data channel and to reproduce the multimedia data according to the applied volume information.

9. The system of claim 8, wherein the transmission terminal transmits the control command to the reception terminal through the control channel when the control command is input, and the reception terminal performs a function corresponding to the received control command.

10. The system of claim 9, wherein the control command comprises volume change, pause, play (Resume), stop, play next file, and play previous file.

11. The system of claim 8, wherein the transmission terminal transmits a gain value corresponding to the current volume to the reception terminal when transmitting the volume information.

12. The system of claim 8, wherein the transmission terminal transmits both a volume index value corresponding to the current volume and a volume mapping table in which a volume index value is mapped to a corresponding gain value to the reception terminal when transmitting the volume information.

13. The system of claim 8, wherein the data channel is a communication channel of a Transmission Control Protocol (TCP) type or a User Datagram Protocol (UDP) type, and the control channel is a communication channel of a Real Time Streaming Protocol (RTSP) type.

14. A portable terminal, comprising:
a display unit;
a communication unit configured to transmit multimedia data to a reception terminal over a data channel and to transmit a control command for controlling reproduction of the multimedia data to the reception terminal over a control channel;
an input unit configured to receive user input for the control command; and
a controller configured to form the data channel and the control channel to transmit a control command when activating a wireless video transmission mode to transmit the multimedia data wirelessly, to control the communication unit the transmit the multimedia data to the reception terminal through the data channel when transmission of the multimedia data is requested, and to control the communication unit to transmit a current volume information to the reception terminal through the control channel.

15. The portable terminal of claim 14, wherein the controller comprises:
a data generation unit configured to generate media clip data into a size suitable for wireless transmission;
a data conversion unit configured to convert the media clip data into a form suitable for the wireless transmission; and
a data transmission unit configured to control the communication unit to transmit the converted data to the reception terminal via the data channel.

16. The portable terminal of claim 14, wherein the controller controls the communication unit to transmit the control command to the reception terminal when the control command is input via the input unit.

17. The portable terminal of claim 14, wherein the control command comprises volume change, pause, play (Resume), stop, play next file, and play previous file.

18. The portable terminal of claim 14, wherein the controller controls the communication unit to transmit a gain value corresponding to the current volume to the reception terminal when transmitting the volume information.

19. The portable terminal of claim 14, wherein the controller controls the communication unit to transmit a volume index value corresponding to the current volume and a volume mapping table in which a volume index value is mapped to a corresponding gain value to the reception terminal when transmitting the volume information.

20. The portable terminal of claim 14, wherein the data channel is a communication channel of a Transmission Control Protocol (TCP) type or a User Datagram Protocol (UDP) type, and the control channel is a communication channel of a Real Time Streaming Protocol (RTSP) type.
